(19) United States
(12) Patent Application Publication
(10) Pub. No.: US 2006/0200976 A1
(43) Pub. Date: Sep. 14, 2006

(54) Tool for the ESD-safeguarded mounting of a detector module

(76) Inventors: Andreas Freund, Heroldsbach (DE); Peter Hackenschmied, Nuernberg (DE); Thomas Reichel, Heroldsbach (DE); Erwin Schobert, Uttenreuth (DE)

Correspondence Address: HARNESS, DICKEY & PIERCE, P.L.C., P.O.BOX 8910, RESTON, VA, 20195, US

(21) Appl. No.: 11/355,002

(22) Filed: Feb. 16, 2006

(30) Foreign Application Priority Data
Feb. 17, 2005 (DE) 10 2005 007 487.1

(51) Int. Cl. H01R 43/00

(52) U.S. Cl. 29/825

(57) ABSTRACT

A tool for the ESD-safeguarded mounting of a detector module is disclosed. The tool includes an accommodating element for accommodating at least one module plug of the detector module, in which case it is possible, when the module plug is accommodated, for an electrostatic charge on the detector module to flow away by way of an electrical connection between the module plug and an ESD-safeguarded operator actuating the tool. As such, it is not necessary to intentionally touch module-side contact-making devices of the module plug, and/or the risk of damage to the signal-processing electronics, which are to be brought into contact with the detector module, as a result of overvoltages is avoided.

The present application hereby claims priority under 35 U.S.C. §119 on German patent application number DE 10 2005 007 487.1 filed Feb. 17, 2005, the entire contents of which is hereby incorporated herein by reference.

### FIELD

The invention generally relates to a tool for the ESD-safeguarded mounting of a detector module.

### BACKGROUND

DE 101 35 288 A1 has disclosed a detector for a computer tomograph which includes a plurality of adjacent detector modules. On the one hand, the individual detector modules can be mechanically connected to a module carrier and, on the other hand, it is possible for electrical contact to be made between them and a printed circuit board via a plug-in connection.

In this case, each detector module includes a so-called module head, on which detector elements are arranged which are lined up to form columns and rows. The respective module head is fixed on the module carrier mechanically, for example by way of a screw connection, and is aligned in relation to an X-ray source such that a defined part of a measurement region is sensed.

Electrical contact is made with the detector module by use of a module plug, which is connected to the module head via flexible conductor tracks in the form of a flexible cable and is plugged on into a slot on the printed circuit board when mounted by an operator who is safeguarded against electrostatic discharges, for example by an ESD-safeguarded technician.

In order to protect the highly sensitive signal-processing components on the printed circuit board against overvoltage damage (ESD damage), it is necessary for the operator to touch the contact pins located on the rear of the module plug with his fingers before the module plug is plugged on. It is thus possible for electrostatic charges present on the detector module to flow away via the operator. The module plug can then be inserted into the slot without there being the risk of damage to the signal-processing components.

In practice, it has been shown, however, that the mounting procedure of detector modules, when viewed as a whole, is so complex, however, that often the operator forgets to intentionally touch the contact pins of the module plug. In this case, mounting of the detector modules is associated with the risk of damage to the signal-processing components.

### SUMMARY

One object of at least one embodiment of the present invention is to specify an auxiliary device(s) for a detector module, with which ESD-safeguarded mounting of the detector module is ensured in a simple manner such that the risk of damage to signal-processing electronics associated with the detector module is reduced.

In accordance with at least one embodiment of the invention, the tool includes an accommodating element for the purpose of accommodating at least one module plug of the detector module, in which case it is possible, when the module plug is accommodated, for an electrostatic charge on the detector module to flow away by way of an electrical connection between the module plug and an ESD-safeguarded operator actuating the tool.

The module plug is therefore no longer plugged onto a slot on the printed circuit board, as has until now been conventional, by the operator directly by hand, but by way of the tool according to at least one embodiment of the invention, in which case, owing to the fact that the module plug of the detector module is accommodated in the accommodating element of the tool, an electrical connection between the module plug and the ESD-safeguarded operator is automatically produced. A result is that a charge on the detector module can flow away via the ESD-safeguarded operator even without him intentionally touching contact pins.

It is no longer possible for the operator to forget to make electrical contact with the module plug prior to mounting the detector module when using this tool, as a result of which the risk of damage to signal-processing electronics associated with the detector module is reduced. Furthermore, the use of the tool during mounting makes one working step superfluous, namely the operator INTENTIONALLY touches the contact pins of the module plug with his hands.

Electrical contact between the module plug and the tool can be produced in a particularly simple manner when the accommodating element has a tool-side contact-making device provided for this purpose. The tool-side contact-making device is preferably mounted in a resilient manner such that, when the module plug is accommodated, the tool-side contact-making device bears against a module-side contact-making device of the module plug.

In one advantageous variant of at least one embodiment of the invention, the tool-side contact-making device is in the form of a metal part, and the module-side contact-making device is at least in the form of a rear contact pin of the module plug. Contact is thus made with the module plug using simple devices via the rear contact pins, which are provided in any case on a module plug. No complex modifications of the detector module are therefore necessary when using the tool for mounting purposes.

The charges transferred to the tool when the module plug is accommodated can be passed on in a particularly simple manner within the tool to the ESD-safeguarded operator when the accommodating element has a conductive material. A suitable conductive material is, for example, metal or a conductive plastic.

The tool advantageously includes an operating element for the purpose of alternately displacing the accommodating element between an initial position accommodating the module plug and a holding position securing the module plug. The alternate displacement between an initial position and a holding position can take place, for example, by way of manual actuation of the operating element and makes it possible for a module plug to be plugged on rapidly.

The charges of the detector module which are transferred to the accommodating element can be dissipated in a particularly simple manner via the ESD-safeguarded operator when the operating element, as is the case with the accommodating element in one example embodiment, has a conductive material. A likewise suitable conductive material is advantageously, for example, a metal or a conductive plastic.

In accordance with one example refinement of at least one embodiment of the invention, the accommodating element includes a first accommodating part and a second accommodating part, and the operating element includes a first operating part and a second operating part, the first accommodating part being mechanically connected to the first operating part, and the second accommodating part being mechanically connected to the second operating part, and the two operating parts being mounted in a resilient manner with respect to one another via a coupling element such that the accommodating element can be brought from the initial position accommodating the module plug into a holding position securing the module plug by the two operating parts being pushed together.

A tool having such a design can be produced in a simple manner and typically includes two narrow, elongate operating parts of equal length which are gripped at the rear end by one of the operator's hands and are held together in the center by way of a coupling element in the form of a resiliently mounted hinge, in a similar manner to the functional principle of a clothespin. The accommodating elements are located at the front end.

A first accommodating pin may be associated with the first accommodating part, and a second accommodating pin is associated with the second accommodating part, it being possible for the two accommodating pins, in the initial position, to be moved into or out of two holes associated with the module plug. Further, the two accommodating pins in the holding position may be pushed in the transverse direction of the accommodating pins against side walls of the holes in the module plug. In order to accommodate and hold the module plug, the holes which are provided in the module plug in any case can thus be used for fixing the plug to the printed circuit board.

### BRIEF DESCRIPTION OF THE DRAWINGS

Example embodiments of the invention and further advantageous refinements of the invention in accordance with the dependent claims are illustrated in the following schematic drawings, in which:

FIG. 1 shows a view, which is partially perspective and partially in the form of a block diagram, of a computer tomograph having a detector which comprises a plurality of detector modules which can be brought into contact with a printed circuit board,

FIG. 2 shows a perspective view of a detail of the detector shown in FIG. 1 having two adjacent detector modules, a module plug of one detector module as yet not having been plugged onto a corresponding slot of a printed circuit board, and

FIG. 3 shows a front view of a tool according to at least one embodiment of the invention for making ESD-safeguarded contact between the detector module shown in FIG. 2 and the printed circuit board.

### DETAILED DESCRIPTION OF THE EXAMPLE EMBODIMENTS

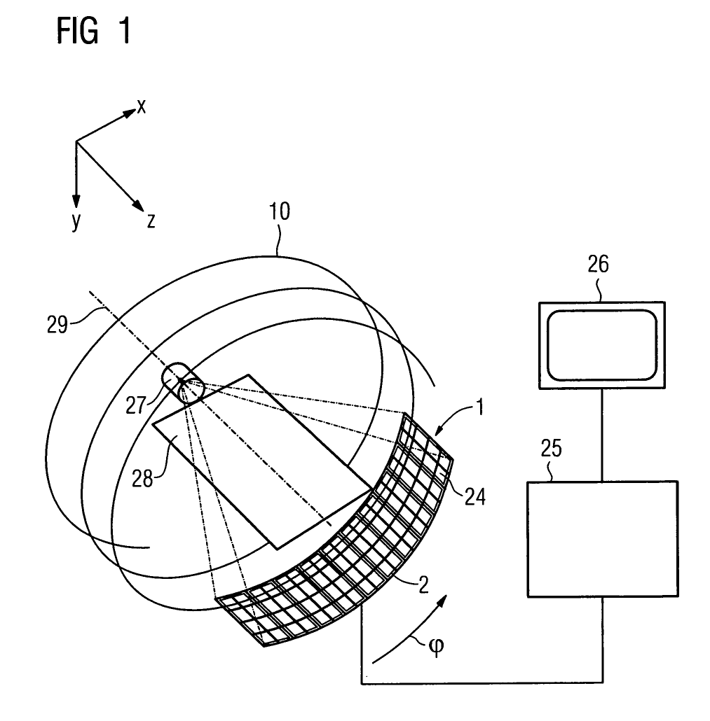

FIG. 1 shows a view, which is partially in the form of a block diagram and partially perspective, of a computer tomograph. A mounting apparatus for the computer tomograph comprises a movable tabletop 28, by which an object to be investigated, for example a patient, can be moved through an opening in the housing of the computer tomograph into a measurement region of a recording system associated with the computer tomograph. The object and the measurement region of the recording system can thus be displaced with respect to one another.

The recording system has an X-ray source 27, for example an X-ray tube, and a detector 1, which is arranged opposite said X-ray source 27 and is formed from a plurality of detector modules 2, which are arranged adjacent in the p direction shown and of which one is provided with a reference symbol. Each detector module 2 includes a plurality of detector elements 24 lined up to form columns and rows. For reasons of clarity, likewise only one of these detector elements 24 is provided with a reference symbol in FIG. 1.

The X-ray source 27 produces a fan-shaped X-ray bundle. The X-ray bundle passes through the object positioned in the measurement region of the recording system and impinges on the detector elements 24 of the detector. The detector elements 24 of the respective detector module 2 each produce an output signal which is dependent on the attenuation of the X-ray radiation passing through the measurement region.

The X-ray radiation is converted into measured values, for example, by means of a photodiode which is optically coupled to a scintillator or by way of a directly converting semiconductor. A set of output signals from all of the detector modules of the detector 1 which are recorded for a specific position of the X-ray source 27 in relation to the object is referred to as “projection”.

A gantry (not illustrated), on which the recording system is arranged, is located within the computer tomograph. The gantry can be rotated about the system axis 29 of the computer tomograph by means of a drive unit (not illustrated) at a high rotational speed. A large number of projections can thus be made from various projection directions of the object.

Owing to a rotation of the gantry at the same time as a continuous advancing movement of the object in the direction of the system axis 29, in particular an investigation region of the object can be sampled which is greater than the measurement region formed by the recording system. The output signals, which are obtained from various projection directions during helical sampling 10, of the object can be calculated by means of a computation unit 25 so as to form tomograms or volumetric images and can be represented visually on a display unit 26 of an operator.

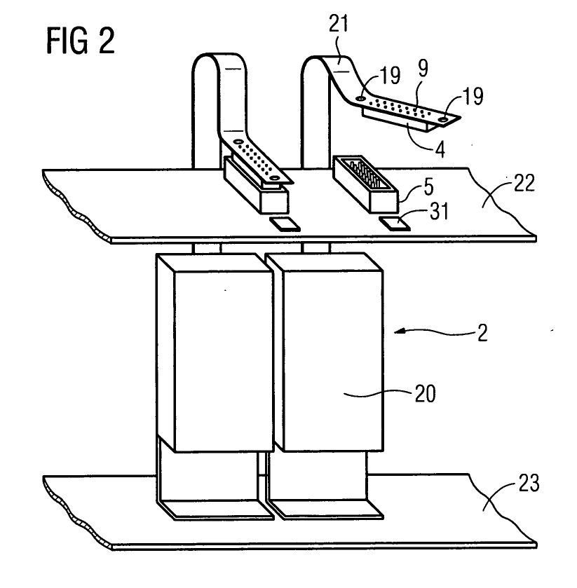

FIG. 2 shows a perspective view of a detail of the detector 1 shown in FIG. 1 having two adjacent detector modules, in which case electrical contact is made between only one of the two detector modules and a printed circuit board, and only this detector module is provided with a reference symbol.

The detector module 2 includes a module head 20, on which detector elements, which are not visible here and are lined up to form columns and rows, are arranged for the purpose of producing the output signals. The respective module head 20 of a detector module 2 is held mechanically on a module carrier 23 and is aligned with respect to the X-ray source 27 shown in FIG. 1 such that a defined part of the measurement region is sensed by the respective detector module 2.

The electrical contact between the respective detector module 2 and a printed circuit board 22 can be produced by way of a module plug 4, which is connected to the module head 20 via flexible conductor tracks 21 in the form of a flexible cable. When the detector module 2 is mounted, the module plug 4 is plugged on into a slot 5 on the printed circuit board 22, with the result that the output signals produced by the detector elements can be transmitted to the printed circuit board 22 via the electrical connection produced. Initial preprocessing of the output signals takes place there by means of a highly sensitive signal-processing component 31 provided for the detector module 2.

In order to protect the highly sensitive signal-processing components 31 against overvoltage damage owing to electrostatic charges present on the detector module 2, it is necessary to ensure that any charges which may be present can flow away before the module plug 4 is plugged onto the slot 5 of the printed circuit board 22.

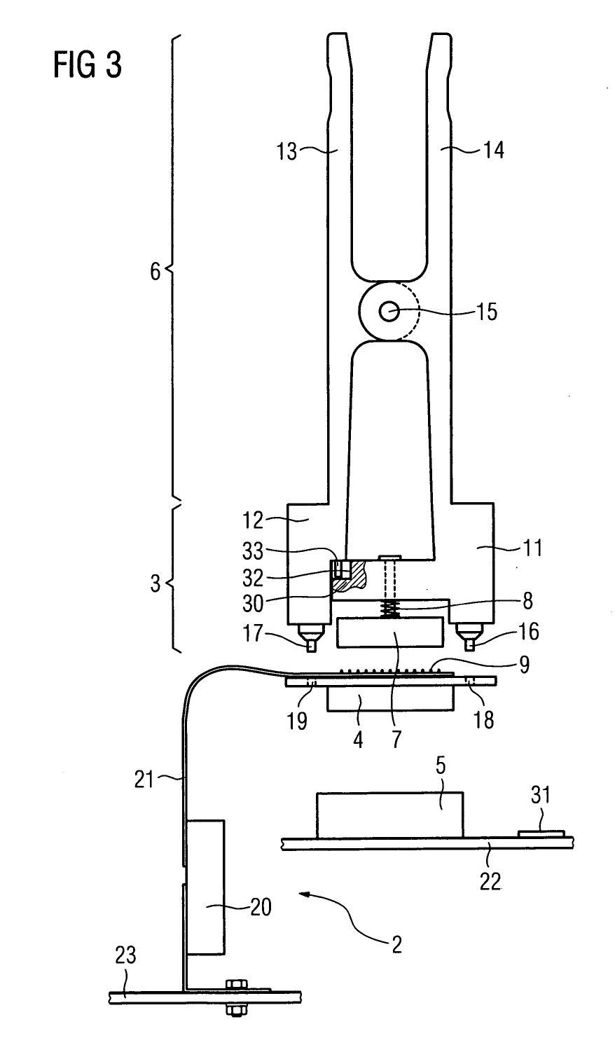

FIG. 3 shows a front view of a tool according to at least one embodiment of the invention for a detector 1, which makes ESD-safeguarded mounting of the detector module 2 possible.

The tool essentially includes an accommodating element 3 for the purpose of accommodating the module plug 4, in which case, when the module plug 4 is accommodated, an electrical connection is produced between the module plug 4 and an ESD-safeguarded operator actuating the tool such that the electrostatic charges which may be present on the detector module 2 can flow away.

In this case, a resiliently mounted tool-side contact-making device 7 is associated with the accommodating element 3 and is pressed against a module-side contact-making means 9 when the module plug 4 is accommodated. An electrical connection is thus automatically produced between the accommodating element 3 of the tool and the module plug 4 of the detector module 2. It is thus no longer necessary for the operator to specially touch the module plug 2 or the module-side contact-making device 9.

The tool-side contact-making device 7 is in the simplest case a metal part, which is mechanically connected to the accommodating element 3 via a resilient spring 8. The contact pins protruding on the rear of the module plug 4 are provided as module-side contact-making device 9, with the result that it is not necessary for the module plug 4 to be redesigned in a complex manner when the tool according to the invention is used. However, other types of tool-side contact-making device 7 or 9 are of course also conceivable. The critical factor is merely that, when the module plug 4 is accommodated in the accommodating element 3 of the tool, electrical contact is automatically made with the detector module 2 without the user intentionally needing to carry out a working step.

The accommodating element 3 can be operated by one hand of the operator via an operating element 6 and can be displaced alternately between an initial position accommodating the module plug 4 and a holding position securing the module plug 4. The accommodating element 3 includes, in detail, a first accommodating part 11, which has the tool-side contact-making means 7, and a second accommodating part 12, and the operating element 6 has a first, elongate operating part 13 and a second elongate operating part 14.

The first accommodating part 11 is mechanically connected to the first operating part 13, and the second accommodating part 12 is mechanically connected to the second operating part 14. The two operating parts 13, 14 are mounted in a resilient manner with respect to one another via a coupling element 15 such that the two accommodating parts 11, 12 are separated from one another by the operator's hand pushing the two operating parts 13, 14 together at the rear end. The accommodating element 11, 12 can thus be displaced from the initial position accommodating the module plug 4 into a holding position securing the module plug 4.

The degree to which the two accommodating parts 11, 12 can be pushed away from one another can be prescribed by way of a displacement unit 30. The displacement unit 30 is in this case formed from a guide rail 32 associated with the first accommodating part 11 and a guide pin 33 associated with the second accommodating part 12, the guide pin 33 being mounted in the guide rail 32.

In order to accommodate the module plug 4 in a simple manner, a first accommodating pin 16 is also provided on the first accommodating part 11, and a second accommodating pin 17 is provided on the second accommodating part 12. In the initial position of the tool, which is always automatically assumed by a resetting spring in the coupling element 15 when the operating element 6 is not pushed together by the operator, the two accommodating pins 16, 17 can be inserted into two holes 18, 19 associated with the module plug 4. When the accommodating pins 16, 17 are inserted into the holes 18, 19 in the module plug 4, at the same time the tool-side contact making device 7 of the tool is pressed against the module-side contact-making device 9, in this case in the form of the rear contact pins of the module plug 4, as a result of which electrical contact is produced between the module plug 4 and the accommodating element 3.

Both the accommodating element 3 and the operating element 6 are made from a conductive material, for example from a metal. When the module plug 4 is accommodated in the accommodating element 3 of the tool, any electrostatic charges present on the detector module 2 are thus dissipated via the ESD-safeguarded operator. When the two operating parts 13, 14 of the operating element 6 are pushed together, the two accommodating parts 11, 12 are separated from one another such that the guide pins 16, 17 of the accommodating element 3 are pressed against the walls of the holes 18, 19 of the module plug 4.

In the pushed-together state of the operating element 6, the tool is in the holding position, in which the module plug 4 of the detector module 2 is held mechanically and detachably by the tool. In the holding position of the tool, the operator can plug the module plug 4 onto the corresponding slot 5 of the printed circuit board 22 without there being the risk of overvoltage damage to the signal-processing components 31. Once the module plug 4 has been plugged on, the mechanical connection between the module plug 4 and the tool is detached again by the operating elements 13, 14 held by the hand being released. The tool assumes its initial position such that the accommodating pins 16, 17 can be guided out of the holes 18, 19 in the module plug 4 without any resistance.

The use of the tool according to at least one embodiment of the invention for a detector for ESD-safeguarded mounting of a detector module is not only restricted to detector modules which are formed from a module head and a module plug which is separate from the module head. It is also possible, of course, for electrical contact to be made with detector modules having a detector frame, in the case of which the module plug is directly associated with the module head. In this case, the accommodating element would expediently be used for accommodating the entire detector module.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A tool for the ESD-safeguarded mounting of a detector module, comprising:
an accommodating element for accommodating at least one module plug of the detector module, wherein it is possible, when the module plug is accommodated, for an electrostatic charge on the detector module to flow away by way of an electrical connection between the module plug and an ESD-safeguarded operator actuating the tool.

2. The tool as claimed in claim 1, further comprising a tool-side contact-making device associated with the accommodating element.

3. The tool as claimed in claim 2, wherein the tool-side contact-making device is mounted in a resilient manner such that, when the module plug is accommodated, the tool-side contact-making device bears against a module-side contact-making device of the module plug.

4. The tool as claimed in claim 2, wherein the tool-side contact-making device is a metal part, and the module-side contact-making device is at least one rear contact pin of the module plug.

5. The tool as claimed in claim 1, wherein the accommodating element includes a conductive material.

6. The tool as claimed in claim 5, wherein the conductive material of the accommodating element is a metal.

7. The tool as claimed in claim 1, further comprising an operating element for alternately displacing the accommodating element between an initial position accommodating the module plug and a holding position securing the module plug.

8. The tool as claimed in claim 7, wherein the operating element includes a conductive material.

9. The tool as claimed in claim 8, wherein the conductive material of the operating element is a metal.

10. The tool as claimed in claim 1, wherein the accommodating element includes a first accommodating part and a second accommodating part, and the operating element includes a first operating part and a second operating part, the first accommodating part being mechanically connected to the first operating part, and the second accommodating part being mechanically connected to the second operating part, and the two operating parts being mounted in a resilient manner with respect to one another via a coupling element such that the accommodating element is brought from the initial position accommodating the module plug into a holding position securing the module plug by the two operating parts being pushed together.

11. The tool as claimed in claim 10, wherein a first accommodating pin is associated with the first accommodating part, and a second accommodating pin is associated with the second accommodating part, the two accommodating pins, the initial position, being movable into or out of two holes associated with the module plug, and the two accommodating pins in the holding position being pushed in the transverse direction of the accommodating pins against side walls of the holes in the module plug.

12. A tool for the ESD-safeguarded mounting of a detector module, comprising:
an accommodating element to accommodate at least one module plug of the detector module, wherein when the module plug is accommodated, an electrical connection between the module plug and an ESD-safeguarded operator actuating the tool permits an electrostatic charge on the detector module to flow away.

13. The tool as claimed in claim 12, further comprising a tool-side contact-making device associated with the accommodating element.

14. The tool as claimed in claim 13, wherein the tool-side contact-making device is mounted in a resilient manner such that, when the module plug is accommodated, the tool-side contact-making device bears against a module-side contact-making device of the module plug.

15. The tool as claimed in claim 13, wherein the tool-side contact-making device is a metal part, and the module-side contact-making device is at least one rear contact pin of the module plug.

16. The tool as claimed in claim 12, wherein the accommodating element includes a conductive material.

17. The tool as claimed in claim 16, wherein the conductive material of the accommodating element is a metal.

18. The tool as claimed in claim 12, further comprising an operating element for alternately displacing the accommodating element between an initial position accommodating the module plug and a holding position securing the module plug.

19. The tool as claimed in claim 3, wherein the tool-side contact-making device is a metal part, and the module-side contact-making device is at least one rear contact pin of the module plug.
